(19) United States
(12) Patent Application Publication
(10) Pub. No.: US 2004/0147638 A1
(43) Pub. Date: Jul. 29, 2004

(54) Polymer dispersions and methods of making the same

(76) Inventors: Kyu-Jun Kim, Chapel Hill, NC (US); Steve Mochrie, Cary, NC (US); Shi Yang, Cary, NC (US); Corina Ionescu, Cary, NC (US); Alan Toman, Apex, NC (US)

Correspondence Address: MYERS BIGEL SIBLEY & SAJOVEC, PO BOX 37428, RALEIGH, NC, 27627, US

(21) Appl. No.: 10/743,600

(22) Filed: Dec. 22, 2003

Related U.S. Application Data
(63) Continuation-in-part of application No. 10/328,124, filed on Dec. 23, 2002.
(60) Provisional application No. 60/471,006, filed on May 16, 2003.

(51) Int. Cl. C08L 67/00

(52) U.S. Cl. 523/201

(57) ABSTRACT

Core/shell alkyd dispersions including ester linkages of the core formed from secondary or tertiary hydroxy groups demonstrate improved hydrolytic stability while heat aged core/shell alkyd dispersions and core/shell alkyd dispersions reacted with trimellitic anhydride also exhibit reduction in dispersion viscosity.

### CROSS-REFERENCE TO RELATED APPLICATIONS

This application is a continuation-in-part of, and claims the benefit of and priority to the following United States Applications, which are incorporated herein by reference in their entirety: pending U.S. patent application Ser. No. 10/328,124 filed on Dec. 23, 2002 and U.S. Provisional Patent Application Serial No. 60/471,006 filed on May 16, 2003.

### FIELD OF THE INVENTION

This invention relates to resins used in the coatings and paint industries, more particularly, this invention relates to alkyd dispersions.

### BACKGROUND OF THE INVENTION

Environmental concerns over the use of volatile organic compounds have sparked tighter regulations regarding their use in the coatings and paint industries. In an attempt to reduce the use of volatile organic compounds in the coating and paint industries, other compositions, such as water dispersible compositions, are being considered.

Alkyd compositions have been widely used in the coatings and paint industries to provide desirable characteristics for coating and paint mixtures. The use of alkyd compositions in coatings and paints provides, among other things, corrosion resistance and blocking resistance for surfaces to which the coating or paint containing the alkyd composition is applied. The alkyd compositions may also affect the gloss characteristics of the coating or paint applied.

In light of environmental concerns, water-reducible alkyds have been developed and used as alternatives to the conventional solvent based alkyd. The use of water-reducible alkyds in the coatings and paint industries, however, has been limited by the short shelf life of such compositions. The shelf life of water-reducible alkyd compositions used in the coatings and paint industries is dependent, in part, upon the integrity of ester linkages within the alkyd compositions. The ester linkages in the water-reducible alkyd compositions are prone to hydrolysis. Hydrolysis of the ester linkages in a water-reducible alkyd lowers the molecular weight and hinders the performance of the coating or paint.

A number of methods and compositions have been developed in an attempt to improve the stability and shelf life of water-reducible alkyd compositions. For instance, core/shell alkyds have been developed wherein acrylic monomers are grafted to fatty acids and the formed acrylic grafted fatty acids are reacted with hydroxyl terminated alkyds prepared with excess of primary hydroxy functional groups. The acrylic polymer acts as a shell for the alkyd core. The hydrolysis-prone core alkyd developed in this manner is partially protected from water, and hydrolysis, by the shell acrylic polymer.

The core/shell alkyd compositions provide some protection from hydrolysis for the primary ester linkages of the core alkyds, wherein ester linkages are formed from primary hydroxy groups. However, the primary ester linkages of the core/shell alkyds are not immune to hydrolysis and such compositions tend to break down over time due to hydrolysis. Therefore, it would be beneficial to develop a water dispersible polymer composition that may slow the effects of hydrolysis and provide compositions having a longer shelf life or useable life.

Furthermore, some core/shell alkyd dispersions have high viscosities requiring the use of a significant amount of volatile organic compounds in order to achieve useful handling viscosity. In addition, the alkyd dispersions undergo a viscosity drop following manufacturing. The use of a large amount of volatile organic compounds and the viscosity drop of a stored product are undesirable. Therefore, it would be beneficial to develop a core/shell alkyd dispersion with improved viscosity characteristics that is also capable of maintaining a consistent viscosity during storage.

### SUMMARY OF THE INVENTION

Various embodiments of the present invention relate to resins used in coating compositions, paint compositions, and other water dispersible compositions. More particularly, embodiments of the present invention relate to water dispersible polymer compositions including core polymers and shell polymers. In some embodiments of the present invention, the water dispersible polymer compositions exhibit improved storage characteristics over conventional water dispersible polymer compositions due to decreased hydrolysis of the core polymer of the water dispersible polymer. Other embodiments of the present invention provide improved viscosity characteristics over conventional core/shell alkyd dispersion. For example, the viscosity of a core/shell alkyd dispersion may be reduced by heat aging the composition or by reacting the composition with trimellitic anhydride.

A water dispersible polymer according to some embodiments of the present invention includes a core polymer and a shell polymer. The core polymer may include an ester linkage originating from fatty acid in the shell polymer. The core polymer may include ester linkages formed from secondary or tertiary hydroxy groups. The shell polymer may be formed by the radical polymerization of one or more acrylic or ethylenically unsaturated monomers and (meth)acrylic acid in the presence of unsaturated fatty acids. The core polymer and shell polymer may be combined by condensation reaction.

In other embodiments of the present invention, a water dispersible polymer composition includes a core polymer having at least some ester linkages formed from secondary or tertiary hydroxy groups and a shell polymer, wherein the core polymer constitutes at least 10 weight percent of the water dispersible polymer composition. The shell polymer of these embodiments may be formed by the radical polymerization of one or more acrylic or ethylenically unsaturated monomers and (meth)acrylic acid in the presence of unsaturated fatty acids. The core polymer and shell polymer may be combined by condensation reaction.

According to some embodiments of the present invention a water dispersible polymer composition includes a core polymer and a shell polymer wherein the shell polymer is formed in the presence of the core polymer. For instance, the shell polymer may be formed by direct radical polymerization of one or more acrylic or ethylenically unsaturated monomers and (meth)acrylic acid into the core polymer. In such a case, the core polymer may not include an ester linkage originating from fatty acid in the shell polymer. The core polymer may include ester linkages formed from secondary or tertiary hydroxy groups. In some embodiments, at least 5 molar percent of the ester linkages in the core polymer are formed by ester linkages of secondary or tertiary hydroxy groups.

According to other embodiments of the present invention, a core/shell alkyd dispersion may be heat aged to reduce the viscosity of the core/shell alkyd dispersion. Heat aging, or heat treating, involves the exposure of the dispersion to a heat source for a period of time and preferably for a period of time ranging from about 2 hours to about 72 hours or longer. For instance, a core/shell alkyd dispersion may be exposed to a temperature at or between about 65° C. to about 98° C. or higher for a period of about 2 to about 72 hours or more. During exposure, the core/shell alkyd dispersion may or may not be agitated. The heat aging process may also be performed in ambient atmospheric conditions or may be performed in a pressurized system. Heat aging may also be performed in an inert gas atmosphere.

The process of heat aging may be performed on the core/shell alkyd dispersions formed according to embodiments of the present invention or on other core/shell alkyd dispersions.

According to other embodiments of the present invention, a core/shell alkyd composition having reduced viscosity may be formed by reacting a core/shell alkyd with an aromatic anhydride such as trimellitic anhydride. The reaction of the core/shell alkyd with trimellitic anhydride produces a core/shell alkyd having neighboring aromatic acids in the core/shell alkyd. The presence of the neighboring aromatic acids lowers the dispersion viscosity of the core/shell alkyd composition. Trimellitic anhydride reacted core/shell alkyd compositions of the present invention may include between about 0 to about 50 percent by weight, and may preferably include up to about 25 percent by weight, of trimellitic anhydride.

In other embodiments of the present invention, a water dispersible polymer composition is used to form a coating, paint, or adhesive composition. The water dispersible polymer composition includes a core polymer having at least some ester linkages formed from secondary or tertiary hydroxy groups combined with a shell polymer. The shell polymer may include a shell polymer formed by the radical polymerization of one or more acrylics or ethylenically unsaturated monomers and (meth)acrylic acid in the presence of unsaturated fatty acids and combined with the core polymer by a condensation reaction. Alternatively, the shell polymer may be formed by direct radical polymerization of one or more acrylics or ethylenically unsaturated monomers and (meth)acrylic acid into the core polymer. The water dispersible polymer composition may be heat aged to reduce the viscosity of the water dispersible polymer composition. The water dispersible polymer composition may also include trimellitic anhydride according to embodiments of the present invention. The water dispersible polymer composition may be combined with additives to form a desired coating or paint composition. For example, a paint composition may be formed by combining the water dispersible composition with pigments, water and other additives.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention relates to resins used in, for example, coating compositions, paint compositions, adhesive compositions, ink compositions, and other water dispersible compositions. More particularly, embodiments of the present invention relate to water dispersible polymer compositions including core polymers and shell polymers wherein the core polymers of the water dispersible polymer compositions include hydrolytically stable ester linkages. For instance, various embodiments of the present invention comprise core/shell polymer dispersions wherein the core polymer includes at least some ester linkages formed from secondary hydroxy groups, tertiary hydroxy groups, sterically hindered hydroxy groups and/or sterically inaccessible crowded ester linkages of hyper-branched or dendritic polyesters. For example, ester linkages may be formed from poly styrene-allyl alcohol or other polyol compounds.

Hydrolysis of ester linkages in core polymers of core/shell polymer dispersions decreases the stability of the core/shell polymer dispersion. Hydrolysis occurs when water from a dispersion reacts with the ester linkage of the core polymer. The hydrolysis of ester linkages in a core polymer destabilizes the core/shell polymer dispersion and detracts from the dispersion's coating performance. Thus, reduced or slowed hydrolysis of ester linkages in core/shell polymers may improve the performance of the core/shell polymers in water dispersible polymer compositions, such as paints, inks, adhesives and coatings.

Ester linkages in the core polymers according to various embodiments of the present invention include those formed from the reaction of carboxylic acids with secondary or tertiary hydroxy groups. These linkages are different from the primary ester linkages of conventional water dispersible polymer compositions, which are formed from the reaction of carboxylic acids with primary hydroxy groups. Formation of an ester linkage using the secondary or tertiary hydroxy groups of a core polymer protects the core polymer from hydrolysis. The protection of a secondary or tertiary hydroxy ester linkage in a core polymer may result from steric hindrance, or the presence of hydrophobic hydrocarbons that may help keep water away from the ester linkage. Consequently, hydrolysis of the ester linkages of the core polymers in the water dispersible polymer compositions according to the present invention are reduced or slowed, resulting in improved water dispersible polymer compositions having longer shelf lives and improved stability. Ester linkages in the core polymers according to various embodiments of the present inventions may be formed from the reaction of carboxylic acids with sterically hindered primary hydroxyl groups in poly (styrene-allyl alcohol) or other polyol compounds. Ester linkages in the core polymers according to various embodiments of the present invention are sterically inaccessible due to highly crowded nature of hyper-branched or dendritic polyesters.

According to embodiments of the present invention, a water dispersible polymer composition comprises a core polymer and a shell polymer, wherein the core polymer includes hydrolytically stable ester linkages. The core polymer may include an ester linkage originating from fatty acid in the shell polymer. The water dispersible polymer composition according to these embodiments may preferably comprise between about 5 weight percent and about 95 weight percent of a core polymer and between about 95 weight percent and about 5 weight percent of a shell polymer. Lower and/or higher weight percentages of the core and shell polymers may also be used with embodiments of the present invention.

In various embodiments of the present invention, a water dispersible polymer composition comprises a core/shell polymer composition having secondary and/or tertiary hydroxy ester linkages formed from the combination of a core polymer with a shell polymer. To form the water dispersible polymer composition, a precursor of core polymer may be prepared and combined with a precursor of shell polymer. The precursor of core polymer may be prepared with excess hydroxy groups, wherein at least a portion of the hydroxy groups include secondary or tertiary hydroxy groups. A precursor of shell polymer, to be combined with a precursor of core polymer, may be prepared by radical polymerization of at least one ethylenically unsaturated monomer and (meth)acrylic acid in the presence of unsaturated fatty acids. Combination of the core polymers and shell polymers may be accomplished through a condensation reaction.

Alternatively, a shell polymer may be formed by radical polymerization of at least one ethylenically unsaturated monomer and (meth)acrylic acid in the presence of the core polymer such that a condensation reaction to combine the core polymer and shell polymer is unnecessary. In those cases, the core polymer may not include the ester linkage originating from fatty acid in the shell polymer.

According to some embodiments of the present invention, the core polymer is formed such that at least 5 molar percent of core polymer ester linkages are formed from secondary and/or tertiary hydroxy groups. In other embodiments, 15 molar percent or more of core polymer ester linkages are formed from secondary and/or tertiary hydroxy groups. The core polymer may be an alkyd polymer or a polyester.

In some embodiments of the present invention, about 10 to about 90 percent by weight of the core/shell polymer composition is a core part polymer with up to about 70 percent by weight of the core part polymer being formed from an epoxy compound and/or a diisocyanate. Epoxy compounds may become an integrated part of the core part polymer by reacting with hydroxy and/or carboxy functional groups and the diisocyanate compounds may become an integrated part of the core by reacting with hydroxy groups. The shell part polymer makes up about 90 to about 10 percent by weight of the core/shell polymer composition. The core part and shell part polymers according to such embodiments may be combined by a condensation reaction between the core and shell polymers.

Core polymers according to embodiments of the present invention may be formed from compounds comprising excess hydroxy groups, such as primary, secondary, and/or tertiary hydroxy-containing polyols. Examples of polyols that may be used include, but are not limited to, primary hydroxy-containing polyols such as trimethylol propane, pentaerythritol, di-pentaerythritol, trimethylol ethane, neopentyl glycol, ethylene glycol, 1,3-butanediol, 1,4-butanediol, 1,6-hexanediol, 1,4-cyclohexyl dimethanol, diethylene glycol, triethylene glycol, poly (ethylene glycol), poly (tetrahydrofuran), poly(caprolactone) diol, poly(caprolactone) triol, trimethylol mono allylether, trimethylol diallyl ether, pentaerythritol triallylether, pentaerythritol diallyl ether, pentaerythritol mono allylether, 2-ethyl-2-(hydroxymethyl)-1,3-propanediol, and 2-methyl 1,3-propanediol. Secondary hydroxy-containing polyols may also be used to form core polymers according to embodiments of the present invention. Such polyols include, but are not limited to, 2,2,4-trimethyl pentanediol, 2,2,4-trimethyl-1,3-pentanediol, 2,2′-bis(4 -hydroxycyclohexy) propane (hydrogenated bisphenol A), propylene glycol, dipropylene glycol, poly (propylene glycol), glycerol, and sorbitol.

In other embodiments, polyacids may be used alone or in combination with other acid compounds to form a core polymer. Some examples of polyacids that may be used to form core polymers according to embodiments of the present invention include, but are not limited to, isophthalic acid, terephthalic acid, 5-(sodiosulfo)-isophthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, and phthalic anhydride.

Core polymers may also be formed from epoxy compounds and/or diisocyanates. Epoxy compounds that may be used with embodiments of the present invention include, but are not limited to, diglycidyl ethers of Bisphenol A and F or their higher molecular weight homologues, diglycidyl ether of hydrogenated Bisphenol A, and epoxy compounds derived from diol and epichlorohydrin. Examples of diisocyanates that may be used to form core part polymers according to embodiments of the present invention include aromatic or aliphatic polyisocyanates, 4,4′-diphenylmethane diisocyanate, 4,4′-diphenylether diisocyanate, 2,4-tolylene diisocyanate, 2,2,4-trimethylhexamethylene diisocyanate, 3-isocyanatemethyl-3,5,5-trimethylcyclohexyl isocyanate, 1,6-hexamethylene diisocyanate, 1,4-butane diisocyanate, 1,6-hexane diisocyanate, isophorone diisocyanate, 1,3- and 1,4-cyclohexane diisocyanate.

In other embodiments, the core polymer may be formed with mono-functional acids, such as saturated or unsaturated fatty acids. For example, one or more mono-functional acids, such as sunflower fatty acid, toll oil fatty acid, linseed oil fatty acid, safflower oil fatty acid, benzoic acid, dehydrated castor oil fatty acid, soybean oil fatty acid, and aliphatic hydrocarbon acids may be used to form the core polymer. If the core polymer is formed from a fatty acid and it is to be used with a water dispersible polymer composition in an air-drying application where ambient curing without additional crosslinkers is desired, at least a portion of the fatty acids may include unsaturated fatty acids.

Oils with air-drying capabilities may also be used in place of the fatty acids in the formation of core polymers. Some examples of oils that may be used to form the core polymers include, but are not limited to, sunflower oil, toll oil, soybean oil, linseed oil, tung oil, castor oil, dehydrated castor oil and safflower oil. When oils are used, an adjustment to the hydroxy/carboxy equivalent ratio of the polymer may be made.

In some other embodiments of the present invention, the core polymer may be formed from an alkyl substituted epoxy compound and an alkyl substituted cyclic carbonate compound. Examples of alkyl substituted epoxy compounds that may be used to form the core polymer include, but are not limited to, glycidyl neodecanoate, diglycidyl ether of bisphenol A, diglycidyl ethers of bisphenol F, pentaerythriol polyglycidyl ether, sorbitol polyglycidyl ether, and propylene oxide. Examples of alkyl substituted cyclic carbonates that may be used to form a core polymer includes propylene carbonate and butylene carbonate.

Shell polymers, according to some embodiments of the present invention, may be formed separately from the core polymer and combined with the core polymer using a condensation reaction. The shell polymers may be formed by radical polymerization of at least one ethylenically unsaturated monomer and (meth)acrylic acid in the presence of unsaturated fatty acids. In some embodiments, the shell polymer comprises up to about 90 weight percent of an unsaturated fatty acid. Shell polymers formed according to these embodiments may be combined with a core polymer by a condensation reaction wherein a carboxy group in a fatty acid and hydroxy group in an alkyd are reacted by heating a mixture of the core and shell polymers. The condensation reaction results in a core/shell polymer dispersion that may be used with water dispersible polymer compositions.

In other embodiments, the shell polymers may be formed by the radical polymerization of acrylic monomers and (meth)acrylic acid in the presence of unsaturated fatty acids. Examples of acrylic monomers useful with embodiments of the present invention include, but not limited to, styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate.

In other embodiments of the present invention, shell polymers may be formed in the presence of the core polymer. In such embodiments, a shell polymer is formed by polymerization of one or more ethylenically unsaturated monomers and (meth)acrylic acid in the presence of a core polymer. The formation of the shell polymer in the presence of the core polymer produces a core/shell polymer dispersion that may be used with water dispersible polymer compositions.

Examples of ethylenically unsaturated monomers that may be used to form shell polymers according to embodiments of the present invention include, but are not limited to, styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate. In those instances where the shell polymer is to be combined with a core polymer by a condensation reaction, the use of hydroxy functional (meth)acrylates may be limited to a level that avoids gellation of the core and shell polymers during a condensation reaction.

Examples of fatty acids that may be used to form shell polymers according to embodiments of the present invention include, but are not limited to, sunflower fatty acid, toll oil fatty acid, linseed oil fatty acid, safflower oil fatty acid, dehydrated castor oil fatty acid, and soybean oil fatty acid.

Amines may also be reacted with the core/shell polymers of the present invention to form salts with the carboxy groups originating mostly in the shell part polymer. The amount of amine reacted may be dependent upon the acid value of the polymers but a pH value of between about 5.0 and about 11.0, or more preferably, between about 7.0 and about 9.0 is desirable to obtain a stable dispersion. Amines that may be used with embodiments of the present invention include, but are not limited to, aqueous ammonia, triethyl amine, N,N-dimethyl ethanol amine, and N-methyl morpholine.

The formation of a shell polymer according to some embodiments of the present invention may also include the use of a radical initiator. Radical initiators that may be used to form the shell polymer include, but are not limited to, di-t-amyl peroxy cyclohexane, t-amyl peroxy-2-ethyl-hexanoate, t-butyl peroxy benzoate, di-t-butyl peroxide, t-butyl hydroperoxide, cumene hydroperoxide, and t-butyl peroctoate.

The compositions may be thinned and/or neutralized to form water dispersions. For example, core/shell polymer compositions formed from (meth)acrylic acid may be thinned with a hydrophilic organic solvent and neutralized with a neutralizing agent, such as an amine, in water to form a dispersion. The amount of organic solvent that may be used depends upon the desired application. However, for many water dispersible polymer compositions the amount of organic solvent in the water dispersible polymer composition may be between 0 to about 30 weight percent based upon the weight of the resin solids in the water dispersible polymer composition. The amount of amine, or neutralizing agent, used to form the dispersion may be determined by the acid value of the dispersion and/or the desired pH of the dispersion. For instance, in many coating applications, a pH value of between about 5.0 and about 11.0, and more preferably between about 7.0 and about 9.0 is desired. Therefore, a sufficient amount of neutralizing agent may be added to the dispersion to reach the desired pH value.

Organic solvents that may be used to thin or reduce the viscosity of the core/shell polymer compositions include, but are not limited to, butoxy ethanol, butoxy propanol, propoxy propanol, methoxy propanol, dipropylene glycol methylether, tripropylene glycol methylether, dipropylene glycol n-butyl ether, and t-butoxy propanol. Useful amines for neutralizing water dispersible polymer compositions include, but are not limited to, aqueous ammonia, triethyl amine, N,N-dimethyl ethanol amine, and N-methyl morpholine.

According to embodiments of the present invention, water dispersible polymer compositions comprise core/shell polymer compositions and other additives, such as thinners, neutralizers, pigments, water, or the like, which may be used to form dispersions for use in water dispersible polymer compositions. Water dispersible polymer compositions utilizing the core/shell polymers according to the present invention may be useful in inks, adhesives, ambient temperature curing coatings, coatings requiring crosslinkers, such as melamine cross-linked coatings and multi-functional isocyanate cross-linked coatings.

Despite reduced or slowed hydrolysis of ester linkages in core/shell polymers formed according to embodiments of the present invention, hydrolytically stable core/shell alkyd dispersions may exhibit viscosity problems. When low levels of solvent are used during the production of hydrolytically stable core/shell alkyd dispersions some core/shell alkyd dispersions have a high viscosity. The high viscosity during manufacturing may be due to extended and stretched polymer configurations occurring after introduction of water. Alkyd dispersions also exhibit signs of viscosity drop during storage. The viscosity changes observed during storage may result from the polymer chains in the core/shell dispersions undergoing morphological changes from extended structures to compressed structures. This may be due to repulsion between hydrophobic polymer chains and water added to the dispersions. The prevalence of high viscosity during manufacturing and the viscosity drops observed during storage are undesirable. Therefore, methods and processes for improving the viscosity characteristics of core/shell alkyd dispersions are desirable.

According to embodiments of the present invention, core/shell alkyd dispersions or polymer compositions formed according to the embodiments of the invention may be heat aged to reduce the viscosity of the core/shell alkyd dispersion. Heat aging of a core/shell alkyd dispersion includes the exposure of a core/shell alkyd dispersion to a heat source for a period of time following or during manufacturing. For instance, a core/shell alkyd dispersion may be exposed to a thermal source imparting a temperature in the core/shell alkyd dispersion at or between, for example, about 65° C. to about 98° C. or higher over a period of time, and preferably between about 2 to about 72 hours or longer. Heat aging may also be performed at other temperatures and pressures, for example between about 40° C. and about 120° C. or higher. It is believed that the exposure of the core/shell alkyd dispersion to the heat source shortens the time required for the polymer chains in the core/shell polymer dispersion to rearrange into a thermodynamically stable compressed form that is not subject to viscosity changes. As a result, the heat aged core/shell alkyd dispersion exhibits improved viscosity stability.

During heat aging, the core/shell alkyd dispersion may or may not be agitated. It has been found that the absence of agitation may facilitate a faster heat aging process. This may result from a lack of agitation shear forces stretching the polymer chains. Furthermore, the heat aging process may occur in an ambient atmosphere or in a pressurized reaction system. If a pressurized system is used, the temperatures to which the core/shell alkyd dispersions are exposed may be 100° C. or more, and the pressure in the heat aging system may speed up the heat aging process. It has been found that heat aging processes with higher temperatures decrease the amount of time required for the process.

According to other embodiments of the invention, heat aging may be applied to core/shell polymers formed from other compounds. For instance, in some embodiments the core polymer may be formed from epoxy compounds, aromatic isocyanates and/or aliphatic isocyanates. In other embodiments the core polymer may include hyper-branched or dendritic polyester of which ester linkages have hydrolytic stability due to steric inaccessibility of water afforded by their highly crowded nature. In still other embodiments, the core polymer may be a fatty acid modified poly (styrene-allyl alcohol) of which ester linkages have hydrolytic stability due to its proximity to hydrophobic acrylic polymer backbone. According to other embodiments of the invention, the core polymer may be alkyd or polyester with ester linkages having hydrolytic stability due to steric hindrance or a highly hydrophobic nature of primary hydroxy groups, for example, cyclohexyl dimethanol and 2-butyl-2-ethyl-1,3-propanediol. The core polymers of various embodiments of the present invention may also be epoxy or urethane modified. In any case, a heat aging process may be applied to a core/shell alkyd or polymer dispersion to reduce the viscosity of the core/shell alkyd or polymer dispersion.

Water dispersible polymer compositions may comprise heat aged core/shell polymer compositions according to embodiments of the present invention and other additives, such as thinners, neutralizers, pigments, water, or the like, which may be used to form dispersions for use in water dispersible polymer compositions. Water dispersible polymer compositions utilizing the heat aged core/shell polymers according to the present invention may be useful in inks, ambient temperature curing coatings, air-drying coatings, coatings requiring crosslinkers, such as melamine crosslinker coatings and multi-functional isocyanate crosslinker coatings.

According to other embodiments of the present invention, the viscosity of a core/shell alkyd dispersion may be reduced by reacting trimellitic anhydride with a hydroxy group of a core alkyd in the core/shell alkyd dispersion. The reaction of trimellitic anhydride with the hydroxy group of the core alkyd generates two neighboring aromatic acids, which lowers the dispersion viscosity of the core/shell alkyd dispersion.

Embodiments of the present invention may include core/shell alkyd dispersions having about 5 to about 95 percent by weight of a core polymer, about 95 to about 5 percent by weight of a shell polymer and trimellitic anhydride, with up to about 25 percent by weight of trimellitic anhydride being preferred.

In other embodiments of the present invention, a core/shell alkyd dispersion may be reacted with trimellitic anhydride and subjected to a heat aging process to alter the viscosity characteristics of the core/shell alkyd dispersion.

Various examples of core/shell alkyd compositions and water dispersible polymer compositions employing the core/shell alkyd compositions according to the present invention are described in Examples 1-32. Examples 1-11 relate to core/shell alkyd compositions formed according to embodiments of the present invention and Example 10 offers a comparative example of conventional core/shell alkyd dispersions. Examples 12-22 relate to core/shell alkyd compositions formed according to other embodiments of the present invention. Examples 23-25 describe the formation of a core/shell alkyd dispersion according to embodiments of the present invention and heat aging of the core/shell alkyd dispersion according to embodiments of the present invention. Examples 26-34 illustrate methods for forming core/shell alkyd dispersions and trimellitic anhydride treated core/shell alkyd dispersions according to the present invention.

Although the Examples provide details for forming core/shell alkyd dispersions and carrying out various embodiments of the present invention, the Examples are not meant to be limiting in any way.

### EXAMPLE 1

A precursor of alkyd core polymer was synthesized with primary and secondary hydroxy polyols. To a flask were charged 130 parts of pentaerythritol, 370 parts of trimethyl pentanediol, 660 parts of Pamolyn 210, 330 parts of isophthalic acid, 3 parts of hypophosphorous acid, 50 parts of xylene and 0.5 parts of dibutyltin oxide. The flask was equipped with water receiver. Under nitrogen blanketing, the temperature was heated to 220-230° C. while removing water and xylene. The process continued until the acid value dropped below 5.0. The flask was cooled to 180° C. and 70 parts of glycidyl neodecanoate was charged to the flask. The process continued at 180° C. until the acid value dropped below 1.0.

A precursor of shell polymer was formed by the radical polymerization of ethylenically unsaturated monomers in the presence of fatty acid. A reactor equipped with a cold-water condenser was provided. To the reactor, 1099 parts of sunflower fatty acid, 715 parts of Pamolyn 210, 22 parts of di-t-butyl peroxide, 33 parts of styrene and 3.3 parts of hypophosphorous acid were charged. The reactor was heated to 150° C. under nitrogen atmosphere. At 150° C., a mixture of 514 parts of styrene, 824 parts of isobutyl methacrylate, 689 parts of methacrylic acid and 83 parts of di-t-butyl peroxide was fed into the reactor over a 4-hour time period. When the addition of the monomers was completed, 17 parts of di-t-butyl peroxide was charged over a 30-minute time period as a chaser. The process continued at 150° C. for additional 6 hours.

The two precursor polymers were combined to form a core/shell alkyd dispersion having secondary hydroxy ester linkages. To a reactor were added 500 parts of the synthesized precursor of core polymer and 584 parts of the precursor of shell polymer. The reactor was heated to 190-210° C. under nitrogen blanketing while collecting xylene and water. The process continued for 14 hours and the temperature was lowered to below 170° C. The product of the process was the core/shell alkyd. 539 parts of the product was transferred to a beaker for thinning. To the beaker was added 125 parts of n-butoxy propanol and the temperature was lowered to below 100° C. Under stirring, a mixture of 650 parts of de-ionized water and 40 parts of aqueous ammonia were charged into the beaker. The resulting water dispersion had an NV value of 38.1, a pH of 8.0, a viscosity of 48 Poise at 25° C., and an Acid Value of 30.4. The NV value is the percentage of the weight of sample after heating at 165° C. for 15 minutes divided by the weight of sample before heating.

### EXAMPLE 2

A precursor of alkyd core polymer was synthesized with primary and secondary hydroxy polyols. To a flask equipped with a water receiver were charged 130 parts of pentaerythritol, 350 parts of trimethyl pentanediol, 150 parts of hydrogenated Bisphenol A, 660 parts of Pamolyn 210, 400 parts of isophthalic acid, 3 parts of hypophosphorous acid, 50 parts of xylene and 0.5 parts of dibutyltin oxide. Under nitrogen blanketing, the temperature was heated to 230° C. while removing water and xylene. The process continued until the acid value dropped below 15.0. The flask was cooled to 190° C. and 100 parts of glycidyl neodecanoate was charged to the flask. The process continued at 180° C. until acid value dropped below 3.0.

A precursor of shell polymer was formed by the radical polymerization of ethylenically unsaturated monomers in the presence of fatty acid. A reactor equipped with a cold-water condenser was provided. To the reactor, 1099 parts of sunflower fatty acid, 715 parts of Pamolyn 210, 22 parts of di-t-butyl peroxide, 33 parts of styrene and 3.3 parts of hypophosphorous acid were charged. The reactor was heated to 150° C. under nitrogen atmosphere. At 150° C., a mixture of 514 parts of styrene, 824 parts of isobutyl methacrylate, 689 parts of methacrylic acid and 83 parts of di-t-butyl peroxide was fed into the reactor over a 4-hour time period. When the addition of the monomers was completed, 17 parts of di-t-butyl peroxide was charged over a 30-minute time period as a chaser. The process continued at 150° C. for additional 6 hours.

A core/shell alkyd dispersion having secondary hydroxy ester linkages was formed from the two precursor polymers. To a reactor were charged 500 parts of a precursor of core polymer product and 584 parts of a precursor of shell polymer product. The reactor was heated to 210-220° C. under nitrogen blanketing while collecting xylene and water. The process continued for 9.5 hours and the temperature was lowered to below 170° C. The product of the process was the core/shell alkyd. To a beaker were transferred 504 parts of the core/shell alkyd for thinning. 150 parts of n-butoxy propanol was added to the beaker and the temperature was lowered to below 100° C. While stirring, a mixture of 640 parts of de-ionized water and 47 parts of aqueous ammonia was charged to the beaker. The resulting dispersion had an NV value of 35.1, a pH of 8.3, a viscosity of 24 Poise at 25° C., and an Acid Value of 29.9.

### EXAMPLE 3

In this Example, a precursor of alkyd core polymer was synthesized with primary and secondary hydroxy polyols. To a flask equipped with a water receiver were charged 120 parts of pentaerythritol, 40 parts of trimethyol propane, 900 parts of trimethyl pentanediol, 200 parts of sunflower fatty acid, 830 parts of isophthalic acid and 0.5 parts of dibutyltin oxide. Under nitrogen blanketing, the temperature was heated to 220-230° C. while removing water. The process continued until the acid value dropped below 12.0. The flask was cooled to 180° C. and 120 parts of glycidyl neodecanoate were charged to the flask. The process continued at 180° C. until acid value dropped below 1.0.

A precursor of shell polymer was formed by the radical polymerization of ethylenically unsaturated monomers in the presence of fatty acid. To a reactor equipped with a cold-water condenser were charged 700 parts of sunflower fatty acid, 715 parts of Pamolyn 210, 22 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 516 parts of methacrylic acid and 83 parts of di-t-butyl peroxide were fed into the reactor over 4 hours. When the addition of the monomers was completed, 17 parts of di-t-butyl peroxide were charged over 30 minutes as a chaser. The process continued at 150° C. for an additional 3 hours.

A core/shell alkyd dispersion having secondary hydroxy ester linkages was prepared from the precursor polymers. To a reactor were charged 250 parts of a precursor of core polymer product, 350 parts of a precursor of shell polymer product, and 0.3 parts of dibutyltin oxide. The reactor was heated to 200° C. under nitrogen blanketing while collecting water. The process continued for 5 hours and the temperature was lowered to below 170° C. To the reactor were added 200 parts of butoxy ethanol and the temperature was lowered to below 100° C. While stirring, a mixture of 650 parts of de-ionized water and 35 parts of aqueous ammonia was charged into a flask. The resulting dispersion had an NV value of 39.0, a pH of 7.9, a viscosity of 80 Poise at 25° C., and an Acid Value of 30.0.

### EXAMPLE 4

In this Example, a precursor of alkyd core polymer was synthesized with primary and secondary hydroxy polyols. To a flask equipped with a water receiver were added 160 parts of pentaerythritol, 400 parts of trimethyl pentanediol, 270 parts of hydrogenated Bisphenol A, 500 parts of sunflower fatty acid, 620 parts of isophthalic acid and 0.5 parts of dibutyltin oxide. Under nitrogen blanketing, the temperature was heated to 220-230° C. while removing water. The process continued until the acid value dropped below 10.0. The flask was cooled to 180° C. and 100 parts of glycidyl neodecanoate was charged to the flask. The process continued at 180° C. until the acid value dropped below 1.0.

A precursor of shell polymer was obtained by the radical polymerization of ethylenically unsaturated monomers in the presence of fatty acid. To a reactor equipped with a cold-water condenser were added 700 parts of sunflower fatty acid, 415 parts of Pamolyn 210, 22 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 516 parts of methacrylic acid and 83 parts of di-t-butyl peroxide was fed into the reactor over a period of 4 hours. When the addition of the monomers was completed, 17 parts of di-t-butyl peroxide were charged over 1 hour as a chaser. The process continued at 150° C. for an additional 3 hours.

A core/shell alkyd dispersion having secondary hydroxy ester linkages was prepared from the precursor polymers. To a reactor were charged 250 parts of a precursor of core polymer product, 300 parts of a precursor of shell polymer product, and 0.3 parts of dibutyltin oxide. The reactor was heated to 200° C. under nitrogen blanketing while collecting water. The process continued for 7.5 hours and the temperature was lowered to below 170° C. To the reactor, 180 parts of butoxy ethanol was added and the temperature was lowered to below 100° C. While stirring, a mixture of de-ionized water and 30 parts of aqueous ammonia were charged to the reactor. The resulting dispersion had an NV value of 33.5, a pH of 8.0, a viscosity of 180 Poise at 25° C., and an Acid Value of 22.5.

### EXAMPLE 5

In this Example, a precursor of alkyd core polymer was synthesized with alkyl substituted epoxy. To a flask equipped with a water receiver were added 249 parts of pentaerythritol, 606 parts of Pamolyn 210, 195 parts of isophthalic acid, 8 parts of hypophosphorous acid and 0.5 parts of dibutyltin oxide. Under nitrogen blanketing, the temperature was heated to 210° C. while removing water. The process continued until the acid value dropped below 10.0. The flask was cooled to 160° C. and 630 parts of glycidyl neodecanoate and 0.5 parts of dibutyltin dilaurate were charged to the flask. The process continued at 160-180° C. until the NV (non-volatiles) reached over 96.0.

A precursor of shell polymer was obtained by the radical polymerization of ethylenically unsaturated monomers in the presence of fatty acid. To a reactor equipped with a cold-water condenser were added 880 parts of sunflower fatty acid, 400 parts of Pamolyn 210, 22 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 789 parts of methacrylic acid and 94 parts of di-t-butyl peroxide were fed into the reactor over a period of 6 hours. The process continued at 150° C. for additional 2.5 hours.

A core/shell alkyd dispersion having secondary hydroxy ester linkages was prepared from the precursor polymers. To a reactor were charged 300 parts of a precursor of core polymer product and 240 parts of a precursor of shell polymer product. The reactor was heated to 190° C. under nitrogen blanketing while collecting water. The process continued for 2.5 hours and the temperature was lowered to below 170° C. To the reactor were added 86 parts of n-butoxy propanol and the temperature was lowered to below 100° C. While stirring, a mixture of 648 parts of de-ionized water and 54 parts of aqueous ammonia were charged to the reactor. The resulting dispersion had an NV value of 37.0, a pH of 8.0, a viscosity of 81 Poise at 25° C., and an Acid Value of 27.1.

### EXAMPLE 6

In this Example, a precursor of alkyd core polymer was synthesized with primary and secondary hydroxy polyols. To a flask equipped with a water receiver were added 185 parts of pentaerythritol, 280 parts of hydrogenated Bisphenol A, 606 parts of Pamolyn 210, 240 parts of isophthalic acid, 3 parts of hypophosphorous acid and 0.5 parts of dibutyltin oxide. Under nitrogen blanketing, the temperature was heated to 220° C. while removing water. The process continued until the acid value dropped below 5.0.

A precursor of shell polymer was formed by the radical polymerization of ethylenically unsaturated monomers in the presence of fatty acid. A reactor equipped with a cold-water condenser was provided. To the reactor, 1099 parts of sunflower fatty acid, 715 parts of Pamolyn 210, 22 parts of di-t-butyl peroxide, 33 parts of styrene and 3.3 parts of hypophosphorous acid were charged. The reactor was heated to 150° C. under nitrogen atmosphere. At 150° C., a mixture of 514 parts of styrene, 824 parts of isobutyl methacrylate, 689 parts of methacrylic acid and 83 parts of di-t-butyl peroxide was fed into the reactor over a 4-hour time period. When the addition of the monomers was completed, 17 parts of di-t-butyl peroxide was charged over a 30-minute time period as a chaser. The process continued at 150° C. for additional 6 hours.

A core/shell alkyd dispersion having secondary hydroxy ester linkages was prepared from the precursor polymers. To a reactor were charged 300 parts of a precursor of core polymer product and 353 parts of a precursor of shell polymer product. The reactor was heated to 190-200° C. under nitrogen blanketing while collecting water. The process continued for 13 hours and the temperature was lowered to below 170° C. To the reactor was added 120 parts of n-butoxy propanol and the temperature was lowered to below 100° C. While stirring, a mixture of 950 parts of de-ionized water and 38 parts of aqueous ammonia were charged to the reactor. The resulting dispersion had an NV value of 35.0, a pH of 7.8, a viscosity of 50 Poise at 25° C., and an Acid Value of 24.8.

### EXAMPLE 7

In this Example, a precursor of alkyd core polymer was synthesized with primary and secondary hydroxy polyols. To a flask equipped with a water receiver were added 240 parts of pentaerythritol, 400 parts of hydrogenated Bisphenol A, 300 parts of trimethyl pentanediol, 400 parts of Pamolyn 210, 400 parts of sunflower fatty acid, 620 parts of isophthalic acid and 0.5 parts of dibutyltin oxide. Under nitrogen blanketing, the temperature was heated to 230° C. while removing water. The process continued until the acid value dropped below 10.0. The reaction temperature was lowered to 180° C. and 90 parts of glycidyl neodecanoate was charged to the flask. The temperature was maintained at 180° C. for an additional one hour.

A precursor of shell polymer was obtained by the radical polymerization of ethylenically unsaturated monomers in the presence of fatty acid. To a reactor equipped with a cold-water condenser were added 556 parts of sunflower fatty acid, 477 parts of Pamolyn 210, 18 parts of di-t-butyl peroxide, 26 parts of styrene and 2 parts of hypophosphorous acid. The reactor was heated to 150° C. under nitrogen atmosphere. At 150° C., a mixture of 408 parts of styrene, 655 parts of isobutyl methacrylate, 398 parts of methacrylic acid and 66 parts of di-t-butyl peroxide were fed to the reactor over 4 hours. When the addition of the monomers was completed, 13 parts of di-t-butyl peroxide were charged to the reactor and the process continued at 150° C. for an additional 3 hours.

A core/shell alkyd dispersion having secondary hydroxy ester linkages was prepared from the precursor polymers. To a reactor were charged 290 parts of a precursor of core polymer product and 350 parts of a precursor of shell polymer product. The reactor was heated to 210° C. under nitrogen blanketing while collecting water. The process continued for 4.5 hours and the temperature was lowered to below 170° C. To the reactor were added 200 parts of n-butoxy ethanol and the temperature was lowered to below 100° C. While stirring, a mixture of 1000 parts of de-ionized water and 33 parts of aqueous ammonia were charged to the reactor. The resulting dispersion had an NV value of 32.1, a pH of 8.1, a viscosity of 93 Poise at 25° C., and an Acid Value of 2.1.

### EXAMPLE 8

An example of an air-drying paint made with a water dispersible composition according to embodiments of the present invention follows. To 373.83 grams of the resulting alkyd dispersion prepared in Example 7 were added 199.50 grams of Tipure® R-706 pigment available from DuPont, 99.75 grams of deionized water, and approximately 250 grams of glass beads. The mixture was transferred to a ball mill. The mixture was ground for one (1) hour on a paint shaker to obtain a 7+Hegman Grind. The mixture was then removed from paint shaker. An additional 186.92 grams of the alkyd dispersion prepared in Example 7 were added to the mixture. A premix comprising 5.39 grams of Cobalt Hydrocure® II Drier (OMG), 0.90 grams of Activ® 8 (RT Vanderbilt) and 2.70 grams of Butyl Cellosolve was made and added to the mixture. To the mixture was also added 0.40 grams of aqueous Ammonia to raise the pH of the mixture to about 8.2-8.6. The Stormer viscosity of the mixture was checked to insure that it was within 60-70 KU. The mixture was then filtered through a 10-micron bag into a quart paint can.

The prepared air-drying paint showed excellent stability in pH value and viscosity even after 8 weeks of storage at about 120° F. The pH values and viscosity values of the air-drying paint over time are illustrated in Table I.

TABLE I

| Time | pH | Viscosity in KU |
|---|---|---|
| Initial | 8.5 | 62 |
| 1 week | 8.6 | 57 |
| 4 weeks | 8.6 | 54 |
| 8 weeks | 8.4 | 53 |

The air-drying paint made according to some embodiments of the present invention exhibited the following properties listed in Table II, which confirm that embodiments of the present invention may be used to prepare useful air-drying (ambient curing) paints:

TABLE II

| | |
|---|---|
| Volatiles Organic Compounds | 1.86 lbs/gal |
| Gardner Dry (Hard,) | 40 minutes |
| Zapon Dry (500 grams) | 1 hour 7 minutes |
| Gloss (60°/20°) | 83/55 |
| Pencil Hardness (1 week cure) | F |
| Sward Hardness (1D/3D/7D) | 30/38/38 |
| Regular Humidity Resistance | OK after 500 hours |

### EXAMPLE 9

In this Example, a precursor of alkyd core polymer was synthesized with primary and secondary hydroxy polyols. To a flask equipped with a packed column and water receiver were added 298 parts of pentaerythritol, 170 parts of trimethyl pentanediol, 621 parts of Hydrogenated Bisphenol A, 1190 parts of Pamolyn 210, 536 parts of isophthalic acid and 1.0 parts of dibutyltin oxide. Under nitrogen blanketing, the temperature was heated to 220° C. while removing water. The process continued until the acid value dropped below 10.0. The flask was cooled to 180° C. and 75 parts of glycidyl neodecanoate were charged to the flask. The process continued at 180° C. until the acid value dropped below 2.0.

A shell polymer formed with the core polymer by direct radical polymerization. To a reactor were added 500 parts of a precursor of core polymer product and 350 parts of n-butoxy ethanol. The reactor was heated to 150° C. under nitrogen blanketing. A mixture of 100 parts of methacrylic acid, 100 parts of styrene, 60 parts of isobutyl methacrylate and 15 parts of di-t-butyl peroxide were fed into the reactor over a period of 3 hours. After holding the temperature at 150° C. for 1 hour, the temperature was lowered to below 100° C. To the reactor were added 720 parts of de-ionized water and 70 parts of aqueous ammonia while stirring. The resulting dispersion had an NV value of 42.0, a pH of 8.9, a viscosity of 55 Poise at 25° C., and an Acid Value of 34.3.

### EXAMPLE 10

### COMPARATIVE EXAMPLE

In a comparative Example, a precursor of alkyd core polymer was synthesized without secondary hydroxy polyol. To a flask equipped with a water receiver were added 687 parts of pentaerythritol, 1266 parts of toll oil fatty acid, 407 parts of linseed fatty acid, 537 parts of isophthalic acid and 0.4 parts of dibutyltin oxide. Under nitrogen blanketing, the temperature was heated to 250° C. while removing water. The process continued until the acid value dropped below 5.0. The flask was cooled to 140° C. and 900 parts of xylene was charged to the flask.

The comparative precursor of shell polymer was obtained by the radical polymerization of ethylenically unsaturated monomers in the presence of fatty acid. To a reactor equipped with a cold-water condenser were added 1099 parts of sunflower fatty acid, 715 parts of Pamolyn 210, 43.3 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 789 parts of methacrylic acid and 83 parts of di-t-butyl peroxide were fed into the reactor over a period of 4 hours. When the addition of the monomers was complete, 16 parts of di-t-butyl peroxide were charged to the reactor over 30 minutes as a chaser. The process continued at 150° C. for additional 2 hours.

The comparative core/shell alkyd dispersion was prepared from the precursor polymers. To a reactor were charged 1010 parts of a precursor of core polymer product and 986 parts of a precursor of shell polymer product. The reactor was heated to 190° C. under nitrogen blanketing while collecting water and xylene. The process continued for 3 hours and the temperature was lowered to below 170° C. To the reactor were charged 262 parts of butoxy ethanol and the temperature was lowered to below 100° C. While stirring, a mixture of 1800 parts of de-ionized water and 80 parts of aqueous ammonia were charged to the reactor. The resulting dispersion had an NV value of 39.5, a pH of 7.9, a viscosity of 111 Poise at 25° C., and an Acid Value of 29.6.

### EXAMPLE 11

The storage life of water dispersible polymer compositions may be impaired by the hydrolysis of ester linkages in the polymers of the water dispersible polymer composition. For example, ester linkages in a water dispersible polymer composition may be broken by hydrolysis. The hydrolysis of an ester linkage of an alkyd generates one carboxylic group. The generation of the carboxylic group increases the acid value of the water dispersible polymer composition. Thus, as the ester linkages in a water dispersible polymer composition are broken by hydrolysis, the acid value of the water dispersible polymer composition increases. Using the readily measurable acid value, the progress of hydrolysis in a water dispersible polymer composition, and hence the stability of the composition, may be determined.

Samples of water dispersible polymer compositions were stored for various aging periods at a temperature of 48.9° C. The shelf life of the Examples having core polymers including ester linkages formed from secondary or tertiary hydroxy groups according to some embodiments of the present invention were compared to the shelf life of a water dispersible polymer composition that did not have ester linkages based on secondary or tertiary hydroxy groups in the core polymer. The acid values of the water dispersible polymer compositions formed in Examples 1-7 were measured during storage over time. The acid values of comparative Example 10 were also measured during the same storage period. The results of the measurements are illustrated in Table III. Percentages appearing in parenthesis represent the percent increase in acid value from the initial acid value of the water dispersible polymer composition over time.

TABLE III

| Alkyd | Initial Acid | Acid Value | Acid Value | Acid Value |
|---|---|---|---|---|
| dispersion from | Value Before | at | at | at |
| Example No. | Heating | 6 weeks | 8 weeks | 12 weeks |
| Example 1 | 30.0 | | | 32.4 |
| | | | | (+8.0%) |
| Example 2 | 29.7 | | | 31.9 |
| | | | | (+7.4%) |
| Example 3 | 30.0 | 30.7 | 30.9 | 33.7 |
| | | (+2.3%) | (+3.0%) | (+12.3%) |
| Example 4 | 22.5 | 22.7 | | 24.6 |
| | | (+0.9%) | | (+9.3%) |
| Example 5 | 27.1 | 28.4 | | |
| | | (+4.8%) | | |
| Example 6 | 24.8 | 26.3 | 26.6 | 28.2 |
| | | (+6.0%) | (+7.3%) | (+13.7%) |
| Example 7 | 21.1 | | | 23.8 |
| | | | | (+12.8%) |
| Example 10 | 29.6 | 38.6 | 42.2 | Phase |
| (no secondary | | (+30.4%) | (+42.5%) | separated |
| hydroxy ester | | | | |
| linkages) | | | | |

The increase in the acid values of the product of comparative Example 10 is dramatic over time, culminating in phase separation at twelve weeks. In comparison, the increases in the acid values of the products of Examples 1-7, which were made according to embodiments of the present invention, are much smaller with no phase separations being observed. In fact, the amount of increase in the acid values of Examples 1-7 at the twelve week date are much less than the acid value increase in the comparative Example 10 after just six weeks. This data demonstrates that the water dispersible polymer compositions according to embodiments of the present invention exhibit improved hydrolytic stability, which results in improved shelf lives for such products.

### EXAMPLE 12

A precursor shell part polymer was synthesized. A reactor equipped with a cold-water condenser was charged with 2500 parts of linoleic acids, 6 parts of di-t-butyl peroxide and 1 part of triphenyl phosphite. The reactor was heated to 150° C. under a nitrogen atmosphere. A mixture of 510 parts of styrene, 72 parts of isobutyl methacrylate, 700 parts of methacrylic acid, and 50 parts of di-t-butyl peroxide were fed to the reactor over 4 hours. Upon completion of the addition of monomers, 10 parts of di-t-butyl peroxide was charged over a period of 25 minutes as a chaser. The process continued at 150° C. for additional 3 hours.

### EXAMPLE 13

A precursor epoxy modified core part polymer was synthesized. A flask reactor equipped with a pack column, nitrogen blanketing, and a water receiver was charged with 150 parts of trimethylol propane, 700 parts of epoxy compound (Epotuf 37140), 470 parts of trimethyl pentanediol, 250 parts of linoleic acid and 200 parts of isophthalic acid. The temperature of the reactor was raised to 160° C. and heating was stopped. A mild exotherm was observed. When the temperature dropped below 170° C., the reactor was heated to 210° C. and that temperature was maintained while collecting forming water until AV/NV=10.0 and the reduced viscosity at 75 NV in xylene was 57.0 stokes.

### EXAMPLE 14

280 parts of the shell polymer of Example 12 and 280 parts of the core polymer of Example 13 were charged to a reactor. The reactor was heated to 180° C. under nitrogen blanketing while collecting forming water. The temperature of the reactor was maintained until AV/NV was 71.9 and the reduced viscosity at 70 NV in xylene was 53.0 stokes. The reactor was cooled below 150° C. and 44 parts of t-butoxy propanol was added to the reactor. The reactor was further cooled to below 100° C. and a mixture of 50 parts of aqueous ammonia and 560 parts of deionized water was charged to the reactor with agitation. The resulting epoxy modified alkyd dispersion included non-volatiles (NV) of 43.2, a pH of 9.04, and an acid value of 32.8.

### EXAMPLE 15

To a reactor were charged 310 parts of the shell polymer of Example 12 and 250 parts of the core polymer of Example 13. The reactor was heated to 180° C. under nitrogen blanketing while collecting forming water. The temperature of the reactor was maintained until AV/NV was 64.8 and the reduced viscosity at 70 NV in xylene was 36.5 stokes. The reactor was cooled below 150° C. and 38 parts of t-butoxy propanol was added. The reactor was further cooled to below 100° C. and a mixture of 45 parts of aqueous ammonia and 560 parts of deionized water were charged to the reactor with agitation. The resulting epoxy modified alkyd dispersion had non-volatiles (NV) of 44.4, a pH of 9.01, and an acid value of 30.5.

### EXAMPLE 16

Hydrolytically stable polyester for urethane modified core part polymer was synthesized. 360 parts of pentaerythritol, 945 parts of trimethyl pentanediol, 338 parts of hydrogenated bisphenol A, 720 parts of linoleic acid, 684 parts of isophthalic acid, 1 part of triphenyl phosphate and 1 part of dibutyltin oxide were charged into a four-neck flask equipped with an agitator, a thermometer, a nitrogen inlet, a pack column and a water receiver. The temperature or the flask was raised to 205° C. and maintained while collecting forming water until the AV was 9.0 and the viscosity was 279 stokes. The reduced viscosity at 75 percent NV in xylene was 2.0 stokes and the OHV (hydroxy value) was 187.

### EXAMPLE 17

A precursor urethane modified core part polymer was synthesized. 937.6 parts of the polyester intermediate prepared in Example 16 was transferred to a second flask and 60.7 parts of toluene diisocyanate was charged to the second flask. The reactants were heated and maintained at 95° C. under nitrogen blanketing until the NCO groups disappeared as determined by Infra-Red (IR) spectroscopy. The resulting urethane modified polyester intermediate had a reduced viscosity at 75 NV in xylene of 13 stokes.

### EXAMPLE 18

A precursor of shell part polymer was synthesized. To a reactor equipped with a cold-water condenser, 2329 parts of linoleic acids, 7.6 parts of di-t-butyl peroxide and 1 part of triphenyl phosphite were charged. The reactor was heated to 150° C. under a nitrogen atmosphere. A mixture of 600 parts of styrene, 159 parts of isobutyl methacrylate, 822 parts of methacrylic acid, and 69 parts of di-t-butyl peroxide were fed to the reactor over a period of 4 hours. When the addition of monomers was completed, 12 parts of di-t-butyl peroxide was charged to the reactor over 30 minutes as a chaser. The process continued at 150° C. for additional 3 hours. After cooling to below 120° C., 444 parts of xylene was charged into the reactor.

### EXAMPLE 19

260 parts of a core part polymer as prepared in Example 17, 390 parts of a shell part polymer as prepared in Example 18, and 20 parts of xylene were charged into a four-neck flask equipped with an agitator, a thermometer, a nitrogen inlet, and a water receiver. The reactants were heated to 215° C. and the temperature was maintained while collecting forming water until AV/NV was 73 and the reduced viscosity at 60 NV in xylene was 19 stokes. The flask was then cooled. 194 parts of t-butoxy propanol was charged to the flask when the temperature dropped below 150° C. When the temperature dropped to 80° C., 675 parts of the product solution was transferred to a second flask and a mixture of 460 parts of deionized water and 33 parts of 29 percent ammonium hydroxide was charged to the second flask over a period of 20 minutes. The dispersion was re-heated to 80° C. and held at that temperature for 30 minutes. The resulting urethane modified core/shell alkyd dispersion had an NV of 41.5, a pH of 7.93, a viscosity of 83 stokes, and an acid value (solids) of 33.8.

### EXAMPLE 20

A precursor of urethane modified core part polymer was synthesized 0.853 parts of a polyester intermediate prepared in Example 16 and 84 parts of toluene diisocyanate were charged into a four-neck flask equipped with an agitator, a thermometer, and nitrogen blanketing. The reactants were heated to 80° C. and maintained until the NCO group disappeared as determined by IR spectroscospy. The resulting urethane modified core part intermediate had a reduced viscosity at 75 NV in xylene of 52 stokes and an AV of 7.4. Subsequently, 295 parts of the core part intermediate prepared was transferred to a second flask. 440 parts of a shell intermediate prepared in Example 18, and 20 parts of xylene were charged to the second flask. The reactants in the second flask were heated to 205° C. under nitrogen blanketing and maintained until AV was 69 and the second flask was then cooled to 80° C. 220 parts of t-butoxy propanol was charged to the second flask when the temperature dropped below 150° C. When the temperature dropped to 80° C., a mixture of 680 parts of deionized water and 42 parts of 29 percent ammonium hydroxide were charged to the second flask over a period of 23 minutes. The dispersion was re-heated to 85° C. and that temperature was maintained for 180 minutes. The resulting urethane modified core/shell alkyd dispersion had an acid value (solids) of 28.0 and a pH of 8.09.

### EXAMPLE 21

A primer paint was prepared using an epoxy modified core/shell alkyd dispersion prepared in Example 14. The ingredients of part (A) of Table IV were mixed using a high speed dispersing blade. The pigments and extenders were added in a decreasing order of the oil absorption value. A “rolling-doughnut effect” was maintained during mixing by adjusting the speed of the mixer and/or the viscosity of the mixture. The temperature was maintained below 60° C. during the pigment dispersion. All of the ingredients were ground at high speed to a 5+Hegman gauge. The ingredients of part (B) and the drier premix of part (C) were added to the mixture. The viscosity and the pH of the mixture were adjusted using deionized water and aqueous ammonia.

TABLE IV

| | | | grams |
|---|---|---|---|
| (A) | Epoxy modified core/shell alkyd | | 435.50 |
| | dispersion in Example 14 | | |
| | Triethyl amine | | 5.00 |
| | Butanol | | 5.00 |
| | n-butoxy propanol | | 20.00 |
| | AnntiterraU80 | | 10.00 |
| | Aerosil R972 | | 1.50 |
| | Byk 022 | | 3.59 |
| | Mica 325 | | 17.92 |
| | BIO | | 30.00 |
| | TiPure 900 | | 125.19 |
| | Talc | | 180.00 |
| | Nytal 1250 | | 180.00 |
| | SZP 391 | | 0.00 |
| | Water | | 124 |
| | High speed to 5+ | | |
| | Letdown | | |
| (B) | Epoxy modified core/shell alkyd | | 287.60 |
| | dispersion in Example 3 | | |
| | Aqueous ammonia | | 6.00 |
| | Byk 022 | | 3.59 |
| | Premix and Add | | |
| (C) | n-butoxy propanol | | 20.00 |
| | Cobalt Hydro-Cure (II, 0.05%) | | 2.60 |
| | Mn Hydro- Cure | | 1.50 |
| | Activ 8 | | 0.17 |
| | Skino 2 | | 3.50 |
| | Mix, check pH | | |
| (D) | 10% Laponite sol | | 31.09 |
| | Water | | 140.76 |
| | Total | | 1634.51 |
| | PVC | 30.55 | |
| | CPVC | 58.73 | |
| | PVC/CPVC | 0.52 | |
| | VOC | 0.99 | Lbs/gal |
| | WT % | 0.53 | |
| | Vol % | 0.44 | |
| | Solvet % | 5.57 | |

This example illustrates that an epoxy modified core/shell alkyd dispersion may be used to prepare a primer paint.

### EXAMPLE 22

The dispersions formed according to Examples 12-21 were analyzed for hydrolytic stability and the data was recorded and is summarized in Table V. Since the hydrolysis of each ester linkage in polyester and alkyd generates one carboxylic group, the acid value is the most reliable analytical means to monitor the progress of hydrolysis of polymer in water with the storage period. The numbers in parenthesis in Table V represent the increase in acid value after heat aging the dispersion at 48.9° C. The data clearly demonstrate that epoxy or urethane modified core/shell alkyd dispersions show excellent hydrolytic stability.

TABLE V

| | Initial | 1 week | 2 weeks | 3 weeks | 4 weeks |
|---|---|---|---|---|---|
| | Acid value | Acid value | Acid value | Acid value | Acid value |
| Dispersion | (solids) | (solids) | (solids) | (solids) | (solids) |
| Example 14 - Epoxy modified | 75.9 | | 77.5 | | 80.1 |
| core/shell alkyd dispersion | | | (+1.6) | | (+4.2) |
| Example 15 - Epoxy modified | 68.7 | | 69.1 | | 70.9 |
| core/shell alkyd dispersion | | | (+0.4) | | (+2.2) |
| Example 19 - Urethane | 33.8 | 34.2 | | 34.7 | 34.9 |
| modified Core/shell alkyd | | (+0.4) | | (+0.9) | (+1.1) |
| dispersion | | | | | |
| Example 20 - Urethane | 28.0 | 28.7 | 28.7 | 29.0 | 29.8 |
| modified Core/shell alkyd | | (+0.7) | (+0.7) | (+1.0) | (+1.8) |
| dispersion | | | | | |

### EXAMPLE 23

Preparation of a precursor of core polymer: 150 grams of trimethyl pentanediol, 825 grams of trimethyl pentanediol, 160 grams of hydrogenated Bisphenol A, 350 grams of Pamolyn 210 fatty acid, 250 grams of adipic acid, 360 grams of isophthalic acid, and 0.5 grams of dibutyltin oxide were charged into a 5 L flask equipped with pack column, nitrogen blanketing and water collector. The temperature was raised to 210° C. and maintained until AV/NV=7.3 and the reduced viscosity at 75 NV in xylene was 1.3 stokes. The reactor was cooled.

Preparation of a precursor of shell polymer: 1170 grams of Pamolyn 210 fatty acid, 65 grams of Pamolyn 300 fatty acid, and 4 grams of di-t-butyl peroxide were charged into a 5 L flask equipped with monomer feed and nitrogen blanketing. The temperature was raised to 150° C.; a mixture of 319 grams of styrene, 85 grams of isobutyl methacrylate, 436 grams of methacrylic acid, 200 grams of HEM-10 monomer (polyethylene glycol monomethacrylate), and 36 grams of di-t-buyl peroxide was fed into a reactor gradually over 4 hours. When the addition of monomer mixture was completed, 6.5 grams of di-t-butyl peroxide was charged over 30 minutes as a chaser. The process continued for an additional 2.5 hours. The product has a reduced viscosity at 60 NV in xylene the viscosity was 27.5 stokes.

Preparation of core/shell alkyd dispersion: To a reactor were charged 220 grams of a precursor of core polymer product and 370 grams of a precursor of shell polymer product. A reactor was heated to 220° C. under nitrogen blanketing while collecting water. The process continued about 5 hours and the temperature was lowered to below 150° C. To the reactor was added 94 grams of t-butoxy propanol and the temperature was lowered to below 100° C. While stirring a mixture of 650 grams of de-ionized water and 60 grams of aqueous ammonia (about 30% concentration) were charged into the reactor.

### EXAMPLE 24

An alkyd dispersion prepared according to processes of Example 23 was split into two batches and subjected to heat aging according to embodiments of the present invention. The heat aging was performed at 85° C. and the first batch was subjected to mechanical agitation at 200 rpm while the second batch was heat aged without agitation. The viscosity of each batch was measured with Brookfield Viscometer (LVT) at 25° C. after heat aging had been performed for various hours. The viscosities resulting from the heat aging at different times are illustrated in Table VI.

TABLE VI

| Heat aging (hours) | 200 rpm agitation | no agitation |
|---|---|---|
| 0 | 540 poise | 540 poise |
| 3 | 320 poise | 235 poise |
| 6 | 275 poise | 175 poise |
| 10 | 235 poise | 125 poise |
| 15 | 198 poise | 115 poise |
| 20 | 182 poise | 96 poise |
| 26 | 161 poise | 93 poise |

As illustrated by the data in Table VI, heat aging of a hydrolytically stable alkyd dispersion lowers the dispersion viscosity. The effectiveness of the heat aging process is also improved in the absence of mechanical agitation.

### EXAMPLE 25

An alkyd dispersion according to Example 23 was heat aged according to embodiments of the present invention at 85° C. for 20 hours. The heat aged alkyd dispersion and an alkyd dispersion that was not heat aged were placed in an oven at 60° C. The placement of the two samples in the oven corresponds to industry-accepted accelerated test methods for predicting the long-term stability of an alkyd composition at ambient conditions. The effectiveness of the heat aging on the viscosity stability of the heat aged alkyd was tested against the non-heat aged alkyd. Viscosity of the two samples was measured with Brookfield Viscometer (LVT) at 25° C. over a period of time; the results of the viscosity measurements are shown in Table VII.

TABLE VII

| | Heat-aged | Unheated |
|---|---|---|
| Hours in oven | (% initial viscosity) | (% initial viscosity) |
| 0 | 96 poise (100) | 540 poise (100) |
| 16 | 94 poise (98) | 255 poise (47) |
| 40 | 90 poise (94) | 140 poise (26) |
| 64 | 86 poise (90) | 105 poise (19) |

The data indicate that after 64 hours at 60° C., a heat aged hydrolytically stable core/shell alkyd dispersion subjected to the embodiments of the present invention shows only 10% viscosity drop while the sample without heat aging suffers an 81% viscosity drop. This demonstrates that the heat aging processes of the present invention alleviates the viscosity drop of hydrolytically stable core/shell alkyd dispersion during storage.

### EXAMPLE 26

To a reactor equipped with a cold-water condenser, 1850 grams of sunflower fatty acid and 6 grams of di-t-butyl peroxide were charged. The reactor was heated to 150° C. under a nitrogen atmosphere. A mixture of 357 grams of styrene, 50 grams of isobutyl methacrylate, 480 grams of methacrylic acid, and 50 grams of di-t-butyl peroxide were fed to the reactor over a period of 4 hours. Following the addition of the monomers, 9 grams of di-t-butyl peroxide were charged over 25 minutes as a chaser. The process was allowed to continue at 150° C. for an additional 3 hours, producing a shell part polymer.

### EXAMPLE 27

A 5 liter flask equipped with a pack column, nitrogen blanketing, and a water receiver was prepared. The following components were charged to the 5 liter flask: 100 grams of pentaerythritol, 120 grams of trimethylol propane, 834 grams of trimethyl pentanediol, 184 grams of hydrogenated Bisphenol A, 550 grams of sunflower fatty acid, 714 grams of isophthalic acid and 0.5 grams of dibutyltin oxide. The temperature of the reaction was raised to over 210° C. and maintained while collecting water formed from the reaction until the acid value/non-volatiles reached 7.6 and a reduced viscosity at 75 NV in xylene was 3.9 stokes. The resulting composition is a core part polymer according to embodiments of the present invention.

### EXAMPLE 28

A core/shell alkyd dispersion was prepared from the shell part and core part polymers of Examples 26 and 27, respectively. To a flask reactor was charged 300 grams of the shell part polymer of Example 26 along with 300 grams of the core part polymer of Example 27. The reactor was heated to 200° C. under nitrogen blanketing while collecting forming water. The temperature was maintained at 200° C. until a reduced viscosity at 75 NV in xylene was 9.7 stokes. The flask was then cooled below 170° C. and 30 grams of n-butoxy propanol was added to the flask. The flask was further cooled to below 100° C. and a mixture of 44 grams of aqueous ammonia and 580 grams of deionized water was charged to the flask with agitation. The resulting core/shell alkyd dispersion displayed a NV of 45.0, a pH of 9.05, a viscosity of 3400 poise, and an Acid Value (AV) of 26.7.

### EXAMPLE 29

A core/shell alkyd dispersion reacted with trimellitic anhydride was prepared according to embodiments of the present invention. To a reactor was charged 300 grams of a shell part polymer of Example 26 along with 300 grams of core part polymer of Example 27. The reactor was heated to 200° C. under nitrogen blanketing while collecting forming water. The temperature was maintained until a reduced viscosity at 75 NV in xylene was 10.5 stokes The reactor was cooled to 160° C. and 20 grams of trimellitic anhydride was added. After 20 minutes, the reactor was cooled and 30 grams of n-butoxy propanol was charged. The flask was further cooled to below 100° C. and a mixture of 44 grams of aqueous ammonia and 610 grams of deionized water was charged with agitation. The resulting alkyd dispersion displayed a NV of 46.0, a pH of 7.92, a viscosity of 430 poise, and an acide value of 34.9. Compared to the core/shell alkyd dispersion of Example 28, the trimellitic anhydride treated core/shell alkyd dispersion has a much lower dispersion viscosity.

### EXAMPLE 30

A shell part polymer was prepared. To a reactor equipped with a cold-water condenser, 2500 grams of linoleic acid and 6 grams of di-t-butyl peroxide were charged. The reactor was heated to 150° C. under a nitrogen atmosphere. A mixture of 510 grams of styrene, 72 grams of isobutyl methacrylate, 700 grams of methacrylic acid, and 55 grams of di-t-butyl peroxide were fed into the reactor over a time period of 4 hours. Upon completion of the addition of the monomers, 10 grams of di-t-butyl peroxide was charged over a period of 15 minutes as a chaser. The process was continued for three additional hours at 150° C. to produce a shell part polymer according to embodiments of the present invention.

### EXAMPLE 31

A core/shell alkyd dispersion reacted with trimellitic anhydride according to embodiments of the present invention was prepared. To a 3 liter flask equipped with nitrogen blanketing and a water receiver were charged 19 grams of pentaerythritol, 296 grams of hydrogenated Bisphenol A, 197 grams of linoleic acid, 129 grams of isophthalic acid, and 0.3 grams of dibutyltin oxide. The temperature of the mixture was raised to 220° C. and maintained while collecting water formed by the reaction until the acid value/non-volatile value was 16.4 and the reduced viscosity at 70 NV in xylene was 5.3 stokes. Upon reaching those conditions, 64 grams of the shell part polymer of Example 19 was charged to the flask. The temperature was maintained at 210° C. until the acid value/non-volatile value was 17.0 and the reduced viscosity at 70 NV in xylene was 7.5 stokes. The temperature was lowered to 160° C. and 35 grams of trimellitic anhydride was charged to the flask. After 20 minutes the reaction was stopped by adding 60 grams of n-butoxy propanol to the flask. The flask was further cooled below 100° C. and a mixture of 43 grams of aqueous ammonia and 650 grams of deionized water was charged to the flask with agitation. The resulting alkyd dispersion displayed a NV of 46.6, a pH of 9.22, a viscosity of 425 poise, and an acid value of 21.4.

### EXAMPLE 32

A core/shell alkyd dispersion reacted with trimellitic anhydride according to embodiments of the present invention was prepared. To a 3 liter flask equipped with nitrogen blanketing and a water receiver were charged 19 grams of pentaerythritol, 296 grams of hydrogenated Bisphenol A, 197 grams of linoleic acid, 129 grams of isophthalic acid, and 0.3 grams of dibutyltin oxide. The temperature of the mixture was raised to 220° C. and maintained while collecting water formed by the reaction until the acid value/non-volatile value was 12.2 and the reduced viscosity at 70 NV in xylene was 5.7 stokes. Upon reaching those conditions, 146 grams of the shell part polymer of Example 19 was charged to the flask. The temperature was maintained at 210° C. until the acid value/non-volatile value was 29.2 and the reduced viscosity at 70 NV in xylene was 6.7 stokes. The temperature was lowered to 160° C. and 35 grams of trimellitic anhydride was charged to the flask. After 25 minutes the reaction was stopped by adding 60 grams of n-butoxy propanol to the flask. The flask was further cooled below 100° C. and a mixture of 47 grams of aqueous ammonia and 800 grams of deionized water was charged to the flask with agitation. The resulting alkyd dispersion displayed a NV of 45.1, a pH of 8.50, a viscosity of 210 poise, and an acid value of 25.4.

### EXAMPLE 33

A paint was prepared from the core/shell alkyd dispersion treated with trimellitic anhydride of Example 20. To 290 grams of the core/shell alkyd dispersion of Example 20 was added 203 grams of Tipure® R-706 pigment manufactured by DuPont®, 3.6 grams of BYK-156 dispersing agent manufactured by BYK, 0.5 grams of DF-66 defoamer manufactured by Air Products, and 40 grams of deionized water. The mixture was ground with approximately 250 grams of glass beads for about 1 hour until 7+scale in Hegmann Grind is achieved. To the mixture was added an additional 145 grams of the core/shell alkyd dispersion of Example 31. A premix comprising 2.0 grams of Co-Hydrocure II manufactured by OMG, 4.1 grams of Ca-Hydrocure manufactured by OMG, 1.7 grams of Zr-Hydrocure manufactured by OMG, and 0.5 grams of DF-66 defoamer was prepared and added to the mixture with agitation. 60 grams of deionized water was added to the combined mixture and premixture to form a white paint. The paint displayed a pH of 8.85, a viscosity of 95 KU, a volatile organic content of 72 grams per liter and a gloss value of 84/68.

### EXAMPLE 34

A paint was prepared from the core/shell alkyd dispersion treated with trimellitic anhydride of Example 21. To 300 grams of the core/shell alkyd dispersion of Example 21 was added 203 grams of Tipure® R-706 pigment manufactured by DuPont®, 3.6 grams of BYK-156 dispersing agent manufactured by BYK, 0.5 grams of DF-66 defoamer manufactured by Air Products, and 25 grams of deionized water. The mixture was ground with approximately 250 grams of glass beads for about 1 hour until 7+scale in Hegmann Grind is achieved. To the mixture was added an additional 150 grams of the core/shell alkyd dispersion of Example 32. A premix comprising 2.0 grams of Co-Hydrocure II manufactured by OMG, 4.1 grams of Ca-Hydrocure manufactured by OMG, 1.7 grams of Zr-Hydrocure manufactured by OMG, and 0.5 grams of DF-66 defoamer was prepared and added to the mixture with agitation. 75 grams of deionized water was added to the combined mixture and premixture to form a white paint. The paint displayed a pH of 8.42, a viscosity of 93 KU, a volatile organic content of 64 grams per liter and a gloss value of 88/76.

Having thus described certain preferred embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A water dispersible polymer composition, comprising:
a core polymer including ester linkages formed from secondary or tertiary hydroxy groups; and
a shell polymer.

2. The water dispersible polymer composition of claim 1, wherein the core polymer comprises at least one epoxy.

3. The water dispersible polymer composition of claim 2, wherein the at least one epoxy is selected from the group consisting of diglycidyl ethers of Bisphenol A and F or their higher molecular weight homologues, diglycidyl ether of hydrogenated Bisphenol A, and epoxy compounds derived from diol and epichlorohydrin.

4. The water dispersible polymer composition of claim 1, wherein the core polymer comprises at least one diisocyanate compound.

5. The water dispersible polymer composition of claim 4, wherein the at least one diisocyanate compound is selected from the group consisting of 4,4′-diphenylmethane diisocyanate, 4,4′-diphenylether diisocyanate, 2,4-tolylene diisocyanate, 2,2,4-trimethylhexamethylene diisocyanate, 3-isocyanatemethyl-3,5,5-trimethylcyclohexyl isocyanate, 1,6-hexamethylene diisocyanate, 1,4-butane diisocyanate, 1,6-hexane diisocyanate, isophorone diisocyanate, 1,3- and 1,4-cyclohexane diisocyanate.

6. The water dispersible polymer composition of claim 1, wherein the shell polymer comprises at least one acrylic monomer.

7. The water dispersible polymer composition of claim 6, wherein the at least one acrylic monomer at least one acrylic monomer is selected from the group consisting of styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate.

8. A method of forming a water dispersible polymer composition, comprising mixing a core polymer having at least five molar percent of ester linkages formed from secondary or tertiary hydroxy groups with a shell polymer formed by radical polymerization of at least one ethylenically unsaturated monomer and (meth)acrylic acid in the presence of at least one unsaturated fatty acid.

9. The method of claim 8, wherein said shell polymer is formed by radical polymerization of at least one ethlenically unsaturated monomer and (meth)acrylic acid in the presence of at least one unsaturated fatty acid.

10. The method of claim 8, further comprising bonding the core polymer and the shell polymer by condensation reaction.

11. The method of claim 8, further comprising bonding the core polymer and the shell polymer by condensation reaction between a carboxy group in a fatty acid and a hydroxy group in the core polymer.

12. The method of claim 8, further comprising heating the mixture of the core polymer and the shell polymer to a temperature between about 180° C. and about 220° C.

13. The method of claim 8, further comprising reacting the core polymer with trimellitic anhydride.

14. The method of claim 8, further comprising heat aging the mixture.

15. The method of claim 14, wherein the heat aging comprises heating the mixture to about 65° C. or above.

16. The method of claim 14, wherein the heat aging comprises heating the mixture to about 65° C. of above for a period of at least 2 hours.

17. A core/shell polymer composition with ester linkages, comprising a core/shell polymer composition wherein at least 5 molar percent of the ester linkages are secondary or tertiary ester linkages.

18. The core/shell polymer composition of claim 17, wherein the core/shell polymer is a core/shell alkyd.

19. The core/shell polymer composition of claim 17, wherein the core/shell polymer is a core/shell polyester.

20. The core/shell polymer composition of claim 17, further comprising at least one pigment.

21. A water dispersible polymer composition, comprising:
a core/shell polymer composition with ester linkages wherein at least 5 molar percent of the ester linkages are secondary or tertiary ester linkages; and
at least one pigment.

22. A method of improving the viscosity characteristics of a core/shell alkyd dispersion, comprising heat aging a core/shell alkyd dispersion.

23. The method of claim 22, wherein heat aging a core/shell alkyd dispersion comprises:
heating said core/shell alkyd dispersion to a temperature at or above about 65° C. in an ambient atmosphere; and
maintaining said heating for a period of at least about 2 hours.

24. The method of claim 23, further comprising agitating said core/shell alkyd dispersion during said heating.

25. The method of claim 23, wherein heating said core/shell alkyd dispersion comprises heating said core/shell alkyd dispersion to a temperature at or between about 65° C. to about 98° C.

26. The method of claim 23, wherein maintaining said heating for a period of at least about 2 hours comprises maintaining said heating for a period of between about 2 hours to about 72 hours.

27. The method of claim 22, wherein heat aging a core/shell alkyd dispersion comprises:
heating said core/shell alkyd dispersion in a reactor to a temperature of about 100° C. or greater with a pressure greater than atmospheric pressure; and
maintaining said heating for a period of about 2 to about 72 hours.

28. The method of claim 27, further comprising agitating said core/shell alkyd dispersion during said heating.

29. A core/shell alkyd dispersion having improved viscosity characteristics, comprising a heat aged core/shell alkyd dispersion.

30. The core/shell alkyd dispersion of claim 28, wherein at least a portion of the core of the core/shell alkyd dispersion is reacted with trimellitic anhydride.

31. A method of improving the viscosity characteristics of a core/shell alkyd dispersion, comprising reacting the core/shell alkyd dispersion with trimellitic anhydride.

32. A water dispersible polymer composition, comprising:
a core polymer;
a shell polymer; and
trimellitic anhydride.

33. The water dispersible polymer composition of claim 32, wherein the core polymer is formed from at least one compound selected from the group consisting of hydroxy-containing polyols, polyacids, oils, fatty acids, mono-functional acids, and mono-functional alcohols.

34. The water dispersible polymer composition of claim 32, wherein the shell polymer is formed by radical polymerization of at least one acrylic monomer and (meth)acrylic acid in the presence of unsaturated fatty acids.

35. The water dispersible polymer composition of claim 32, wherein the core polymer comprises between about 5 and about 95 weight percent of the water dispersible polymer composition.

36. The water dispersible polymer composition of claim 32, wherein the shell polymer comprises between about 5 and about 95 weight percent of the water dispersible polymer composition.

37. The water dispersible polymer composition of claim 32, wherein the trimellitic anhydride comprises up to about 25 weight percent of the water dispersible polymer composition.

38. A paint composition, comprising:
a pigment;
a core polymer;
a shell polymer; and
trimellitic anhydride.

39. An ink, comprising:
a core polymer;
a shell polymer; and
trimellitic anhydride.

40. An adhesive, comprising:
a core polymer;
a shell polymer; and
trimellitic anhydride.

41. A water dispersible polymer composition, comprising:
a core polymer including ester linkages formed from secondary or tertiary hydroxy groups; and
a shell polymer formed by radical polymerization of at least one acrylic monomer and (meth)acrylic acid in the presence of unsaturated fatty acids.

42. The water dispersible polymer composition of claim 41, wherein said shell polymer comprises at least 5 weight percent of the water dispersible polymer composition.

43. The water dispersible polymer composition of claim 41, further comprising at least one additive selected from the group consisting of thinners, neutralizers, pigments, and water.

44. The water dispersible polymer composition of claim 41, wherein said shell polymer comprises at most 95 weight percent of the unsaturated fatty acids.

45. The water dispersible polymer composition of claim 41, wherein said core polymer comprises between about 5 and about 95 weight percent of the water dispersible polymer composition.

46. The water dispersible polymer composition of claim 41, further comprising at least one organic solvent in an amount between about 5 and about 30 weight percent of the water dispersible polymer composition.

47. The water dispersible polymer composition of claim 41, further comprising trimellitic anhydride.

48. The water dispersible polymer composition of claim 41, wherein said at least one acrylic monomer is selected from the group consisting of styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate.

49. The water dispersible polymer composition of claim 41, wherein the core polymer comprises at least one epoxy compound.

50. The water dispersible polymer composition of claim 49, wherein the at least one epoxy compound is selected from the group consisting of diglycidyl ethers of Bisphenol A and F or their higher molecular weight homologues, diglycidyl ether of hydrogenated Bisphenol A, and epoxy compounds derived from diol and epichlorohydrin.

51. The water dispersible polymer composition of claim 41, wherein the core polymer comprises at least one diisocyanate compound.

52. The water dispersible polymer composition of claim 51, wherein the at least one diisocyanate compound is selected from the group consisting of 4,4′-diphenylmethane diisocyanate, 4,4′-diphenylether diisocyanate, 2,4-tolylene diisocyanate, 2,2,4-trimethylhexamethylene diisocyanate, 3-isocyanatemethyl-3,5,5-trimethylcyclohexyl isocyanate, 1,6-hexamethylene diisocyanate, 1,4-butane diisocyanate, 1,6-hexane diisocyanate, isophorone diisocyanate, 1,3- and 1,4-cyclohexane diisocyanate.

53. A coating composition, comprising:
a core polymer including ester linkages formed from secondary or tertiary hydroxy groups; and
a shell polymer formed by radical polymerization of at least one acrylic monomer and (meth)acrylic acid in the presence of unsaturated fatty acids.

54. The coating composition of claim 53, wherein the core polymer is an alkyd polymer.

55. The coating composition of claim 53, wherein the core polymer is a polyester.

56. The coating composition of claim 53, further comprising at least one pigment.

57. The coating composition of claim 53, further comprising at least one melamine crosslinker.

58. The coating composition of claim 53, further comprising at least one multi-functional isocyanate crosslinker.

59. The coating composition of claim 53, wherein the core polymer and the shell polymer are bonded by a condensation reaction.

60. The coating composition of claim 53, wherein said at least one acrylic monomer is selected from the group consisting of styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate.

61. The water dispersible polymer composition of claim 53, wherein the core polymer comprises at least one epoxy compound.

62. The water dispersible polymer composition of claim 61, wherein the at least one epoxy compound is selected from the group consisting of diglycidyl ethers of Bisphenol A and F or their higher molecular weight homologues, diglycidyl ether of hydrogenated Bisphenol A, and epoxy compounds derived from diol and epichlorohydrin.

63. The water dispersible polymer composition of claim 53, wherein the core polymer comprises at least one diisocyanate compound.

64. The water dispersible polymer composition of claim 63, wherein the at least one diisocyanate compound is selected from the group consisting of 4,4′-diphenylmethane diisocyanate, 4,4′-diphenylether diisocyanate, 2,4-tolylene diisocyanate, 2,2,4-trimethylhexamethylene diisocyanate, 3-isocyanatemethyl-3,5,5-trimethylcyclohexyl isocyanate, 1,6-hexamethylene diisocyanate, 1,4-butane diisocyanate, 1,6-hexane diisocyanate, isophorone diisocyanate, 1,3- and 1,4-cyclohexane diisocyanate.

65. An ink composition, comprising:
a core polymer including ester linkages formed from secondary or tertiary hydroxy groups; and
a shell polymer formed by radical polymerization of at least one acrylic monomer and (meth)acrylic acid in the presence of unsaturated fatty acids.

66. An adhesive composition, comprising:
a core polymer including ester linkages formed from secondary or tertiary hydroxy groups; and
a shell polymer formed by radical polymerization of at least one acrylic monomer and (meth)acrylic acid in the presence of unsaturated fatty acids.

67. A water-dispersible polymer composition comprising a core polymer formed from hydrophobic and bulky alkyl substituted primary polyols; and
a shell polymer.

68. The water-dispersible polymer composition of claim 96, wherein the hydrophobic and bulky alkyl substituted primary polyols are selected from the group consisting of cyclohexyl dimethanol and 2-butyl-2-ethyl-1,3-propanediol.

69. A water-dispersible polymer composition comprising a core polymer formed from poly (styrene-allyl alcohol) and at least one fatty acid; and
a shell polymer.

70. A water-dispersible polymer composition comprising a core polymer and a shell polymer, wherein the core polymer comprises a dendritic and hyper-branched polyester.
